(19) United States
(12) Patent Application Publication
(10) Pub. No.: US 2004/0263632 A1
(43) Pub. Date: Dec. 30, 2004

(54) Printer

(75) Inventor: Soichiro Kimura, Asaka (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/874,542

(22) Filed: Jun. 24, 2004

(30) Foreign Application Priority Data
Jun. 25, 2003 (JP) 2003-180711

(51) Int. Cl. H04N 5/225

(52) U.S. Cl. 348/207.2

(57) ABSTRACT

In a printer having a medium-mounting chamber for mounting a recording medium inside and an operating button on the top, a receiving section receives image data transmitted from an exterior on a radio communication basis. A holding section is held by an operator, which is provided at a side portion of the printer when looking the receiving section at an operator side. A delivery slot delivers a recording medium mounted on the medium-mounting chamber, on which an image is recorded. The delivery slot may be provided at the operator side when looking the receiving section at the operator side, or at the side opposite to the operator side.

### BACKGROUND OF THE INVENTION

1. Field of the Invention

The present invention relates to a printer having a medium-mounting chamber for mounting a recording medium inside and an operating button on the top, in which an image according to image data is recorded on the recording medium mounted on the medium-mounting chamber, and the recording medium on which the image is recorded is outputted to the exterior.

2. Description of the Related Art

There is known a printer for recording a subject image on a recording medium in accordance with image data. In such type of printer, there is one, in which as the recording medium, for example, an instant film is used, and a recording of images on the instant film is performed in accordance with image data recorded on a memory card and the like.

By the way, recently, many types of mobile equipment such as handy terminals come onto the market. Of those types of mobile equipment, there is a printer, and there appears one referred to as a portable printer (cf. Japanese Patent Application Laid Open Gazette TokuKai Hei. 11-193014). As the mobile equipment, a portable telephone is typical. The portable telephones have come into explosive wide use. Some user would consider that a combination of the portable telephone and another portable equipment might implement a system capable of performing information management on a personal basis. The portable telephone is loaded with a large number of applications. The use of those applications makes it possible to perform various types of information management.

### SUMMARY OF THE INVENTION

In view of the foregoing, it is an object of the present invention to provide a printer that is excellent in operability and is satisfactory in operational efficiency.

To achieve the above-mentioned objects, the present invention provides a printer having a medium-mounting chamber for mounting a recording medium inside and an operating button on the top, in which an image according to image data is recorded on the recording medium mounted on the medium-mounting chamber, and the recording medium on which the image is recorded is outputted to the exterior, the printer having:

a receiving section that receives image data transmitted from an exterior on a radio communication basis;

a holding section to be held by an operator, which is provided at a side portion of the printer when looking the receiving section at an operator side, and

a delivery slot that delivers a recording medium mounted on the medium-mounting chamber, on which an image is recorded, the delivery slot being provided at the operator side when looking the receiving section at the operator side, or provided at a side opposite to the operator side.

The combination use of the printer of the present invention particularly with a portable telephone is more effective. That is, when the printer receives image data from the portable telephone through a radio communication, the printer performs recording of an image on a recording medium. According to the printer of the present invention, it is possible to record an image while an operator holds the holding section, or alternatively it is possible to record an image in a state that the printer is placed at a suitable place. Thus, the printer of the present invention is excellent in operability.

In the printer according to the present invention as mentioned above, it is preferable that the delivery slot is disposed at the operator side when looking the receiving section at the operator side and below the receiving section.

According to the printer of the present invention, the receiving section is provided at the upper position than the delivery slot. This structure makes it possible to avoid such a matter that the recording medium delivered from the printer during transmission of image data blocks the transmission.

In the printer according to the present invention as mentioned above, it is preferable that the receiving section is provided at an upper portion over a center in thickness of the printer with respect to a vertical direction.

In the event that the printer is used in combination with a portable telephone, it is considered in many cases that the printer is set at the substantially same height as the portable telephone, or below the portable telephone.

Thus, according to the present invention, the receiving section is provided at an upper portion. This feature makes it possible to more surely receive image data from the portable telephone.

In the printer according to the present invention as mentioned above, it is desired that an instant film, on which an latent image is recorded through exposure, is mounted on the medium-mounting chamber, in which the instant film is exposed in accordance with image data and a developer is developed on the instant film while the instant film is delivered.

This feature makes it possible for the printer to perform a photographic printing in accordance with data transmitted from a portable telephone through a radio communication. Some types of portable telephone have a camera function and/or are capable of obtaining image data through an Internet. According to the printer of the present invention, it is possible to obtain an image according to the image data in form of a photograph.

### BRIEF DESCRIPTION OF THE DRAWINGS

FIG. 1 is a perspective view of a printer according to an embodiment of the present invention.

FIG. 2 is a perspective view of a printer in which an instant film mounted inside the printer is delivered out of the printer.

FIG. 3 is a perspective view of a printer according to an embodiment of the present invention, looking from the back of the printer.

FIG. 4 is a perspective view of a printer, in which a front top cover of the printer is removed, looking the inside of the printer.

FIG. 5 is a typical illustration showing a structure of the optical head shown in FIG. 4.

FIG. 6 is a block diagram showing a control structure inside the printer.

FIG. 7 is a perspective view of a printer according to another embodiment of the present invention.

### DETAILED DESCRIPTION OF PREFERRED EMBODIMENTS

Embodiments of the present invention will be described with reference to the accompanying drawings.

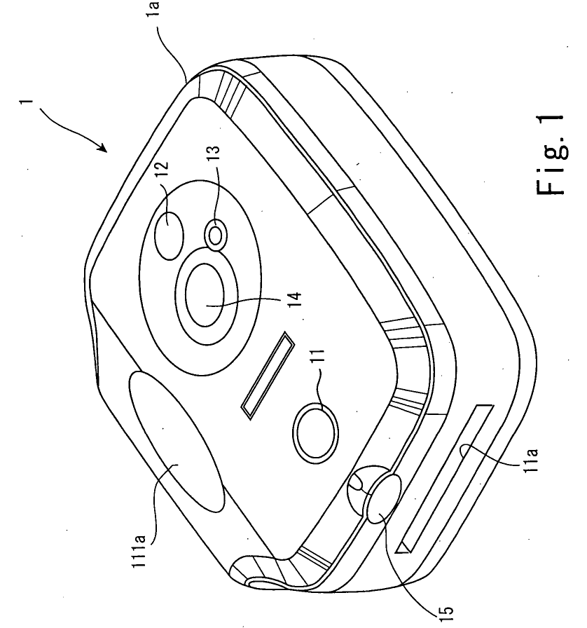

FIG. 1 is a perspective view of a printer according to an embodiment of the present invention.

A printer 1 is used in combination with a portable telephone and the like. According to the printer 1, an instant film is mounted on a medium-mounting chamber. The instant film is exposed in accordance with image data and a developer is developed on the instant film after the instant film is delivered. The instant film corresponds to the recording medium referred to in the present invention. Here, as the recording medium, there is used the instant film. However, it is acceptable to use a common sheet as the recording medium.

In a portable telephone, there is a type capable of performing an infrared communication based on IRDA (Infrared Data Association). The use of the infrared communication makes it possible to transmit one's own information to another information equipment. For example, in case of a portable telephone having a camera, it is possible to transmit image data to the printer.

The printer 1 is to perform a recording of image on an instant film sheet in accordance with image data, when image data representative of an image photographed by the portable telephone having a camera or image data transmitted to the portable telephone through a mail, is transmitted to the printer using the infrared communication. Further, the printer 1 is able to perform a re-recording of an image based on the transmitted image data on another recording medium through such a simple operation that a print switch is operated, without retransmission of image data from the portable telephone.

Hereinafter, there will be explained a structure of a printer according to the present embodiment referring to FIG. 1.

The printer 1 has such a degree of compact and light structure that the printer 1 is portable and is capable of recording an image having both a portable telephone and the printer 1 by one's hand. An instant film pack is mounted on a cover member 1a of the printer 1 so that a recording of an image is carried out one by one on a large number of laminated instant film sheets in the instant film pack.

On the top of the cover member 1a of the printer 1, as operation buttons, there are provided a power source switch 11 for instructing turn-on and turn-off of the power source of the printer 1, a print switch 12, and a print data correction switch 13. At the center of the top of the cover member 1a of the printer 1, there is provided an LCD panel 14 that indicates the number of remainders (unused sheets) of the instant film sheets and contents of the print data correction switch 13. Further, at the edge portion of the cover member 1a, there is provided a receiving section 15 (a photoelectric element) for receiving image data transmitted through the above-mentioned infrared communication. The cover member 1a of the printer 1 has a holding portion 111a to be held by an operator, which is provided at the side portion of the printer 1 when looking the receiving section 15 at the operator side, and a delivery slot 11a for delivering a recording medium mounted on the medium-mounting chamber, on which an image is recorded, the delivery slot 11a being provided at the operator side when looking the receiving section 15 at the operator side.

The delivery slot 11a is disposed at the operator side when looking the receiving section 15 at the operator side and below the receiving section 15.

In other words, the receiving section 15 is provided at a position easy to transmit image data from the portable telephone when the operator holds the holding portion 111a with one's hand. And the delivery slot 11a is disposed below the receiving section 15 so that the instant film can be delivered out of the printer 1 while the operator holds the holding portion 111a with one's hand. In this manner, when the receiving section 15 and the delivery slot 11a are provided at the operator side when looking the receiving section 15 at the operator side, and the holding portion 111a is provided at the side portion of the printer 1 when looking the receiving section 15 at the operator side, it is possible for the operator to record images holding the portable telephone with one's hand and holding the printer 1 with one's another hand, and whereby it is excellent in operability.

The holding portion 111a forms a recess on the cover member 1a of the printer 1. This structure makes it easy for a user to hold the printer 1. Thus, while the user holds a portable telephone by one's hand, it is possible for the user to simply hold the holding portion 111a by one's another hand. According to the present embodiment, in view of the fact that a user usually has a portable telephone by one's right hand, the holding portion 111a is provided at a position in which the user can holds the printer 1 by one's left hand. However, the printer 1 is light since it is of a portable type, and thus it is possible for the user to cause the printer 1 to perform recording of images holding the portable telephone by one's left hand, while holding the printer 1 by one's right hand, without holding the holding portion 111a by one's left hand.

After the printer 1 receives image data from the exterior through the infrared communication and the instant film is delivered out of the printer 1, an operation of the print switch 12 on the top of the cover member 1a makes it possible to obtain a copy of the same image. An operation of the print data correction switch 13 makes it possible to alter density of images to be copied. This feature makes it possible to a user to enjoy photographs in different ways. The print data correction switch 13 controls dark or light of images to be recorded on a recording medium. When the print data correction switch 13 is switched to a “DARK” side, an image, which is slightly dark in the entire density of the image according to the image data, is recorded on the instant film. When the print data correction switch 13 is switched to a “LIGHT” side, an image, which is slightly light in the entire density of the image according to the image data, is recorded on the instant film.

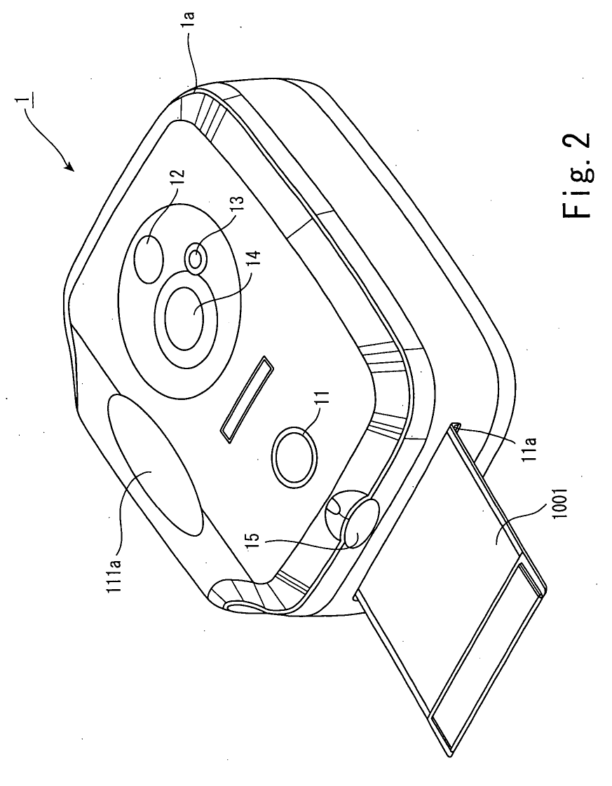

FIG. 2 is a perspective view of a printer in which an instant film mounted inside the printer is delivered out of the printer.

FIG. 2 shows a state that after an optical head, which will be described later, is used to perform a recording of a latent image on an instant film 1001, the instant film 1001 is delivered from the delivery slot of the printer 1, while the latent image on the instant film 1001 is developed.

According to this printer, when the printer receives image data transmitted on a radio basis from the exterior in accordance with the infrared communication, a latent image is recorded on the instant film 1001 through the exposure in accordance with the obtained image data, and the instant film 1001, on which the latent image is recorded, is delivered out of the printer 1, as shown in FIG. 2, while the latent image is developed. Thereafter, also when the print switch 12 is operated, re-recording of the same image is performed on another instant film, and as shown in FIG. 2, the instant film 1001 is delivered out of the printer 1. When a user has the holding portion 111a of the printer 1 by one's hand and has a portable telephone by another hand, and image data is transmitted from the portable telephone to the receiving section through an infrared communication, it is natural that the user has the portable telephone at the ready at the substantially same height of position as the printer 1, or at the slightly higher position. Thus, taking into consideration an operability of the printer 1, the receiving section 15 is provided at the upper position than the delivery slot 11a. This structure makes it possible to avoid such a matter that even if the instant film 1001 is delivered from the printer 1 during the transmission of image data, the delivered instant film 1001 blocks the transmission, and the holding hand obstructs the delivery of the instant film 1001.

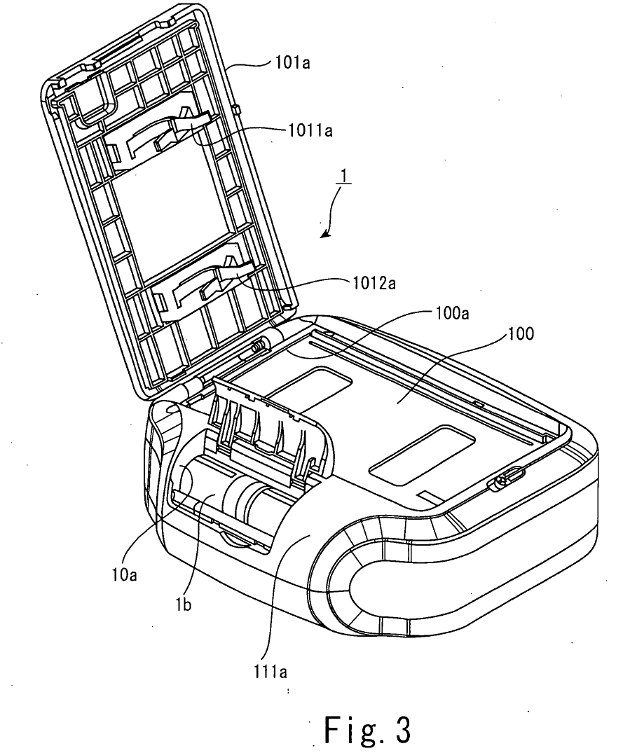

FIG. 3 is a perspective view of a printer according to an embodiment of the present invention, looking from the back of the printer.

At the under side of the printer 1, there is provided a film door 101a for mounting a film pack 100. The film door 101a is opened to mount the film pack 100 on a film-mounting chamber 100a. The film-mounting chamber 100a corresponds to the medium-mounting chamber referred to in the present invention.

A battery-mounting chamber 10a for mounting a battery 1b as a power source for the printer 1 is provided in the vicinity of the film-mounting chamber 100a. The battery-mounting chamber 10a also has a door. The door is opened to mount the battery 1b.

Inside the film door 101a, there are provided two spring members 1011a and 1012a. The spring members 1011a and 1012a push the instant film sheets laminated in the instant film pack 100 to the upper side of the printer 1. This structure causes the instant film sheet 1001, which is located at the top, of the instant film sheets in the instant film pack 100, to be pushed to the upper side of the printer 1, so that a large number of points, which is focused on the instant film sheet pushed to the upper side of the printer 1, is recorded through an exposure.

Next, there will be explained an internal structure of the printer 1.

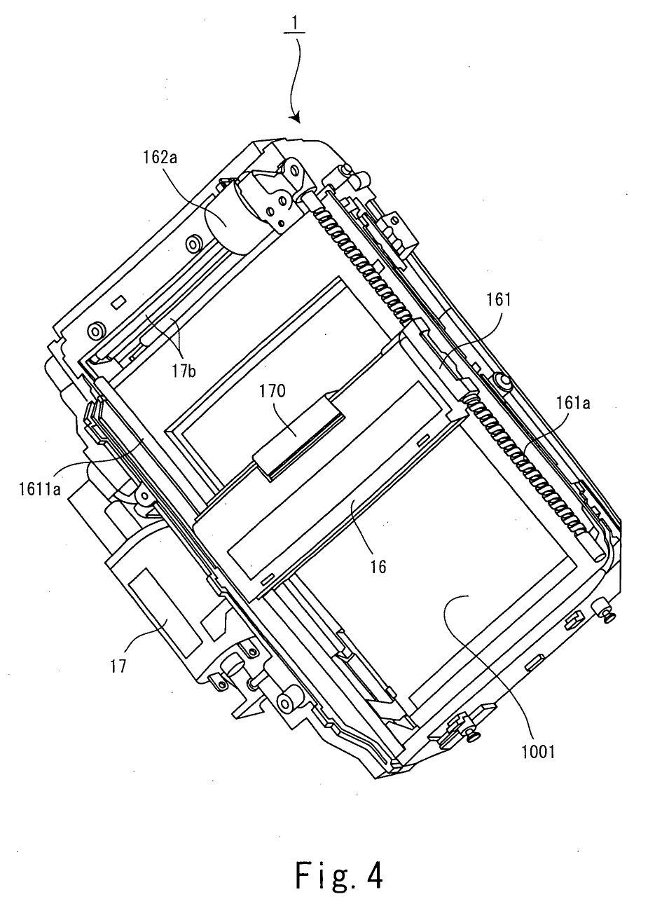

FIG. 4 is a perspective view of the printer 1, in which a front top cover of the printer 1 is removed, looking the inside of the printer 1.

As shown in FIG. 4, there is disposed an optical head section 16 at the position opposite to the instant film sheet 1001, which is located at the top, of the instant film sheets laminated in the instant film pack mounted inside the printer.

At an edge portion of the optical head section 16, there is provided a head key 161, which is elastically engaged with a screw of a lead screw 161a supported by the cover member 1a on a spiral basis. At the opposite side to the side wherein the head key 161 of the optical head section 16 is provided, there is provided a guide rod 1611a with which the edge portion of the optical head section 16 is engaged. While the guide rod 1611a guides the optical head section 16, the optical head section 16 is moved by engagement of the lead screw 161a with the head key 161.

As shown in FIG. 4, the optical head section 16 is connected with a flat cable 170 via which a control signal according to image data is fed from a printing control section that will be described later. The control signal controls shutter speeds of shutters of a liquid crystal shutter array (that will be described later) of the optical head section 16. The shutter speeds of shutters of the liquid crystal array are controlled in accordance with image data, and the instant film is irradiated with lights that are associated with RGB, respectively, so that a latent image, which consists of 480 pieces of light spots (dots) in a width direction of the instant film, is recorded. Hereinafter, the width direction of the instant film, that is, a direction in which the shutters are arranged on a one-dimensional basis, is referred to as a main scanning direction. Accordingly, when the shutters are electrically scanned in the main scanning direction, a line of 480 pieces of light spots is recorded on the instant film 1001. When the electric scanning of the optical head section 16 causes the light spots consisting of 480 dots to be recorded in the main scanning direction of the instant film 1001, a stepping motor 162a rotates in accordance with the control signal from a printing control section that will be described later, so that the lead screw 161a rotates by a predetermined angle. Then, the optical head section 16 sequentially records light spots 480 dots by 480 dots in a direction intersecting to the main scanning direction. Hereinafter, the direction intersecting to the main scanning direction is referred to as a sub-scanning direction. In the sub-scanning direction, 640 lines of light spots are recorded on the instant film in its entirety, where the corresponding 480 dots of light spots, which are recorded through once main scanning of the optical head section 16, are established as one line.

When a latent image representative of an image is recorded with assembly of the light spots, a developing roller 17 rolls up the instant film sheet 1001 so that developer in the instant film is developed in the instant film sheet 1001 in its entirety, and the latent image is developed and delivered out of the printer. The instant film sheet 1001 is a self-developing processing type of photosensitive material. When the developing roller 17 rolls up the instant film sheet 1001, the developer filled in the instant film is uniformly developed in the instant film sheet 1001 in its entirety so that a latent image on the film sheet is developed. In this manner, while the optical head is moved on the instant film in a predetermined sub-scanning direction, when light spots, which are arranged in a main scanning direction intersecting to the sub-scanning direction, are irradiated in accordance with image data, a latent image is recorded on the instant film.

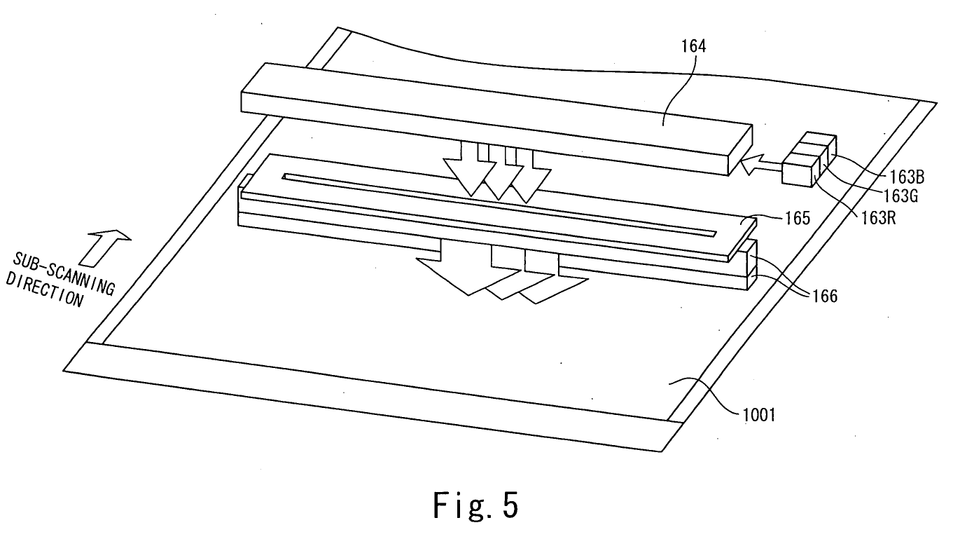

Next, there will be explained a structure of the optical head 16 referring to FIG. 5.

FIG. 5 is a typical illustration showing a structure of the optical head 16 shown in FIG. 4.

FIG. 5 shows an arrangement sequence of light-emitting devices 163R, 163G and 163B arranged on an edge portion of a light introducing plate 164, and a travelling direction of lights of R, G and B, which are projected onto the instant film in form of the light spot, with arrows typically.

As shown in FIG. 5, the optical head 16 comprises the light-emitting devices 163R, 163G and 163B for R, G and B, which are three primary colors of light, the light introducing plate 164, the liquid crystal shutter array 165, and a lens 166.

As will be seen from FIG. 5, the light-emitting devices 163R, 163G and 163B are disposed on an edge portion of the light introducing plate 164. Lights emitted from the light-emitting devices 163R, 163G and 163B are introduced via the light introducing plate 164 to the instant film sheet 1001. The light introducing plate 164 alters courses of lights introduced to the instant film sheet 1001 side, so that the lights are projected onto the instant film sheet 1001. The thus projected lights reach the instant film sheet 1001 via the shutters of the liquid crystal shutter array 165 and Selfoc Lenses (registered trademark) 166. In this manner, lights, which are controlled in light quantity by the shutters of the liquid crystal shutter array 165, are converged on the instant film by Selfoc Lenses (registered trademark) 166 so as to form light spots, and the thus focused light spots are recorded on the instant film. Here, the liquid crystal shutter array 165 consisting of 480 elements is used to control shutter speeds of the shutters in accordance with image data, so that 480 pieces of light spots having gradation according to the image data are recorded on the instant film. This is recorded by the corresponding 640 lines in the sub-scanning direction, so that 480×640 (VGA size) of light spots are recorded on the instant film in form of a latent image. This latent image represents a color image in which lights of three colors of R, G and B are recorded on the same light spot by Selfoc Lenses (registered trademark) 166.

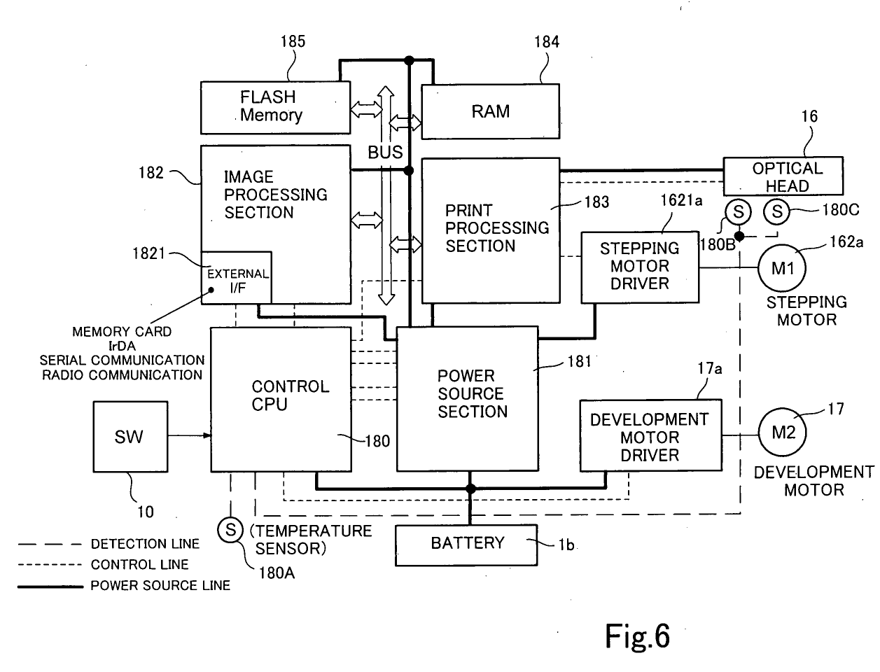

FIG. 6 is a block diagram showing a control structure inside the printer.

As shown in FIG. 6, CPU 180 controls an operation of the printer.

In order to control the printer 1 even if the power source of the printer 1 is broken, an electric power is directly supplied from a battery 1b to the printer 1. While the battery 1b directly supplies further to a power source section 181 and a development motor driver 17a, the power source section 181 and the development motor driver 17a do not operate unless they receive instructions from the CPU 180. Thus, no electric power is consumed for the power source section 181 and the development motor driver 17a. A power supply to an image processing section 182, a stepping motor driver 1621a, a print processing section 183, a RAM 184 that is a volatile storage, a FLASH memory 185 that is a non-volatile storage, and an exterior IF 1821 of the image processing section 182, is performed via the power source section 181. The CPU 180 controls the power source section 181. And no power is supplied to the respective sections unless the CPU 180 instructs. In FIG. 6, power source lines of directly supplying electric power from the battery, and power source lines of supplying electric power from the battery via the power source section are depicted with thick lines, and control lines and detection lines are depicted with dotted lines.

This structure makes it possible that the CPU 180 and the power source section 181 supply electric power to only the necessary sections and thereby contributing to elongating a life time of the battery 1b. Thus, as mentioned above, when the battery 1b is mounted on the battery-mounting chamber 10a of the printer 1, the printer 1 is available for a long time with the battery 1b.

Various sorts of switch 10, such as ones shown in FIG. 1, are connected to the CPU 180. The CPU 180 controls the respective sections shown in FIG. 6 in accordance with operations of the various sorts of switch 10. After the power source switch 11 of the various sorts of switch 10 is turned on, when the printer 1 receives image data from the exterior through the infrared communication or the USB communication, an image recording is performed under the control of the CPU 180 even if the various sorts of switch 10 is not operated.

The CPU 180 receives detection signals from a temperature sensor 180A for detecting a temperature of the optical head 16, a start position sensor 180B for detecting a recording start position of the optical head 16, and a terminal position sensor 180C for detecting a terminal position of the optical head 16. The CPU 180 causes the print processing section 183 to control shutter speeds of the shutters of the optical head 16 in accordance with the detection signal from the temperature sensor 180A. Further, the CPU 180 causes the print processing section 183 to control a stepping motor 162a in accordance with the detection signal from the start position sensor 180B and the terminal position sensor 180C.

Here, there will be explained controls of the CPU 180 for the respective sections when the printer 1 receives image data from the exterior after the power source switch 11 is turned on.

When the printer 1 receives image data from the exterior through the infrared communication, the image processing section 182 having an I/F 1821 outputs a signal to the CPU 180 when the receiving section 15 receives the infrared. Upon receipt of this signal, the CPU 180 causes the image processing section 182 to erase image data of both the RAM 184 and the FLASH memory 185. Further, the CPU 180 causes the image processing section 182 to receive new image data, and causes the RAM 184 to store the received new image data via a bus. The /F 1821 of the image processing section 182 can receive image data even when the image data is transmitted through the USB communication.

After the CPU 180 causes the RAM 184 to store the image data from the exterior, the CPU 180 causes the image data stored in the RAM 184 to be read out to the image processing section 182, so that the image processing section 182 creates print data. The print data indicates data, which is subjected to a suitable processing in the image processing section 182, so that the data can control shutter speeds of the shutters of the optical head 16, but be different from the image data received by the image processing section 182.

After the CPU 180 causes the image processing section 182 to create the print data, the CPU 180 causes the image processing section 182 to transfer the print data, so that the print processing section 183 controls shutter speeds of shutters of the optical head 16. Thus, the aperture times of the shutters arranged in the main scanning direction, that is, the shutter speeds, are controlled in accordance with the print data, so that light quantities for three colors of R, G and B passing through the shutters are controlled, respectively. Further, the CPU 180 causes the print processing section 183 to control the stepping motor driver 1621a so that the stepping motor 162a scans the optical head 16 in the sub-scanning direction. Furthermore, the CPU 180 causes the print processing section 183 to control the shutter speeds of the shutters in accordance with the print data for each scanning, so that the light quantity of each light spot in the sub-scanning direction is controlled. In this manner, quantities of the whole light spots are controlled, so that a latent image representative of an image consisting of assemblies of the light spots is recorded on the instant film.

After the CPU 180 causes the optical head 16 to record the latent image on the instant film, the CPU 180 turns off the power source section 181 and causes the development motor driver 17a to drive the development motor 17.

The development motor 17 rotates the development roller so that while the instant film is rolled up and the developer is developed over the instant film, the latent image is developed and the instant film is delivered to exterior of the printer 1.

The above-mentioned description is concerned with the processing which the CPU 180 causes the respective sections to perform when the printer 1 receives on a radio basis image data through the infrared communication after the power source is turned on by the power source switch 11.

Next, there will be explained processing which the CPU 180 causes the respective sections to perform when the print switch 12 is operated.

When the print switch 12 is operated, the CPU 180 causes the image processing section 182 to read out the image data stored in the RAM 184. And the CPU 180 causes the image processing section 182 to create print data in accordance with the image data thus read and transfer the print data to the print processing section 183. The print processing section 183 controls the shutters of the optical head 16 in accordance with the print data to control a quantity of light to be projected on the instant film. Control of the light quantity of the respective light spot may project the light quantity according to the image data on the instant film, so that a latent image is recorded in accordance with the image data.

The CPU 180 detects, by change of the detection signal of the terminal position sensor 180C, the fact that the recording of the latent image is completed, and issues an instruction of turning off of the power source section 181 to the power source section 181 and also issues an instruction of driving of the development motor 17 to the development motor driver 17a.

The development motor 17 drives a claw (not illustrated) for sending out the instant film to a development roller side to send out the instant film to the development roller side, so that the development roller rolls up the instant film to be delivered out of the printer 1. Rolling up of the instant film by the development roller makes it possible to develop the developer filled up in the instant film onto the instant film in its entirety and develop the latent image.

Thus, when the print switch 12 is operated, an image is recorded on the instant film in accordance with image data stored in the RAM 184.

Thus, the printer 1 makes it possible to record an image on the instant film through transmission of information of a portable telephone on a radio basis. Further, according to the printer 1 of the present invention, it is possible to record an image simply by means of transmission of image data from a portable telephone while a user holds a holding portion of the printer, and thereby implementing a printer that is excellent in operability and is satisfactory in operational efficiency. Further, since this printer is compact and light, it is possible to carry together with a portable telephone. In this manner, the combination of the printer with the portable telephone makes it possible to enhance the function of the printer.

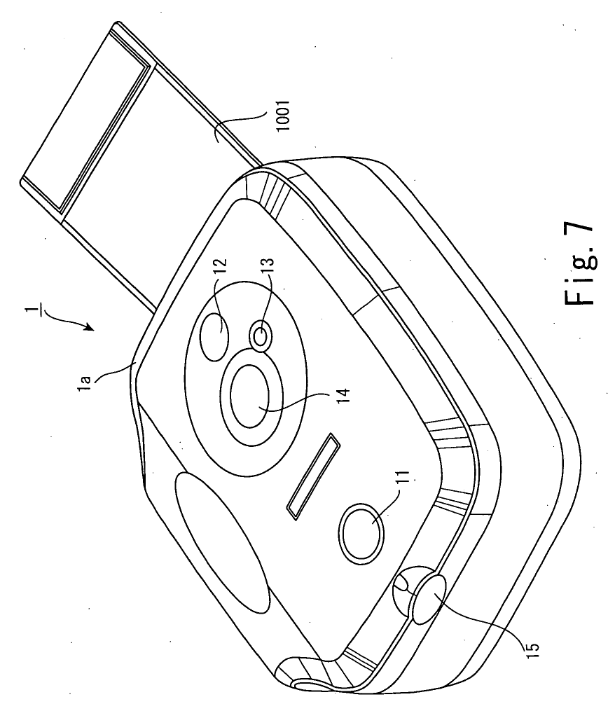

FIG. 7 is a perspective view of a printer according to another embodiment of the present invention.

FIG. 7 shows an example in which a delivery slot (not illustrated) is provided on the opposite side to the receiving section 15.

Also in this case, it is possible to send image data training a transmission section of a portable telephone on the receiving section of the printer, while an operator holds the holding section of the printer 1, and also it is possible to avoid such a matter that the holding section prevents the instant film from being delivered.

Incidentally, according to the present embodiments as mentioned above, there is shown a printer using the instant film. But it is acceptable to adopt an ink jet type of printer.

As mentioned above, according to the present invention, it is possible to provide a printer that is excellent in operability and is satisfactory in operational efficiency.

While the present invention has been described with reference to the particular illustrative embodiments, it is not to be restricted by those embodiments but only by the appended claims. It is to be appreciated that those skilled in the art can change or modify the embodiments without departing from the scope and sprit of the present invention.

What is claimed is:

1. A printer having a medium-mounting chamber for mounting a recording medium inside and an operating button on the top, in which an image according to image data is recorded on the recording medium mounted on the medium-mounting chamber, and the recording medium on which the image is recorded is outputted to the exterior, the printer having:
a receiving section that receives image data transmitted from an exterior on a radio communication basis;
a holding section to be held by an operator, which is provided at a side portion of the printer when looking the receiving section at an operator side, and
a delivery slot that delivers a recording medium mounted on the medium-mounting chamber, on which an image is recorded, the delivery slot being provided at the operator side when looking the receiving section at the operator side, or provided at a side opposite to the operator side.

2. A printer according to claim 1, wherein the delivery slot is disposed at the operator side when looking the receiving section at the operator side and below the receiving section.

3. A printer according to claim 1, wherein the receiving section is provided at an upper portion over a center in thickness of the printer with respect to a vertical direction.

4. A printer according to claim 1, wherein an instant film, on which an latent image is recorded through exposure, is mounted on the medium-mounting chamber, in which the instant film is exposed in accordance with image data and a developer is developed on the instant film while the instant film is delivered.
